(19) United States
(12) Patent Application Publication
(10) Pub. No.: US 2025/0363127 A1
(43) Pub. Date: Nov. 27, 2025

(54) DATA ENCAPSULATION DEVICE AND DATA ENCAPSULATION METHOD

(71) Applicants: Digiwin Software Co., Ltd, Shanghai (CN); DATA SYSTEMS CONSULTING CO., LTD., New Taipei City (TW)

(72) Inventors: Xiaoliang Ma, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/769,403

(22) Filed: Jul. 11, 2024

(30) Foreign Application Priority Data
May 27, 2024 (CN) 202410669878.8

(51) Int. Cl. G06F 16/25; G06F 16/242

(52) U.S. Cl. CPC G06F 16/252; G06F 16/2445

(57) ABSTRACT

Disclosed are a data encapsulation device and a data encapsulation method. The data encapsulation device includes a storage device and a processor. The storage device is configured to store multiple modules. The processor is coupled to the storage device and is configured to execute multiple modules. A model building module obtains a corresponding encapsulated data and a compiler based on a dataset. A knowledge assembly module receives the encapsulated data to generate component data and associated data based on the encapsulated data. The knowledge assembly module assembles multiple component data into a component dataset based on a combination command. A compilation module executes a data compilation process through the corresponding compiler to generate executable data based on the component dataset.

### CROSS-REFERENCE TO RELATED APPLICATION

This application claims the priority benefit of China application serial no. 202410669878.8, filed on May 27, 2024. The entirety of the above-mentioned patent application is hereby incorporated by reference herein and made a part of this specification.

### BACKGROUND

### Technical Field

The disclosure relates to a data processing technology, and in particular to a data encapsulation device and a data encapsulation method.

### Description of Related Art

In the establishment and use of enterprise knowledge data, maintenance and establishment are often carried out through manual methods. However, when the amount of data reaches a certain scale, it might be difficult to use manual methods to maintain and search for associations between multiple pieces of knowledge, and the problem of duplicate establishment of knowledge data might also occur. Therefore, conventional knowledge data establishment methods have problems such as difficulty in establishing associations between knowledge and failure to achieve good reuse effects.

### SUMMARY

The disclosure provides a data encapsulation device and a data encapsulation method, which may automatically perform data encapsulation and data assembly based on entity data and relational data.

Based on embodiments of the disclosure, the data encapsulation device of the disclosure includes a storage device and a processor. The storage device is configured to store multiple modules and component data. The processor is coupled to the storage device and is configured to execute multiple modules. A model building module receives a dataset to obtain corresponding encapsulated data and a compiler from an encapsulated dataset (that is, a combination of multiple encapsulated data) based on features between the datasets. A knowledge assembly module generates the component data and associated data based on the encapsulated data. The knowledge assembly module assembles multiple component data into a component dataset based on a combination command. A compilation module executes a data compilation process through a corresponding compiler to generate executable data based on the component dataset.

Based on embodiments of the disclosure, the data encapsulation method of the disclosure includes the following steps. First, a dataset is received through a model building module to obtain corresponding encapsulated data and a compiler based on the dataset. The encapsulated data is received through a knowledge assembly module to generate component data and associated data based on the encapsulated data. The knowledge assembly module assembles multiple component data into a component dataset based on a combination command. The compilation module executes a data compilation process through the corresponding compiler to generate executable data based on the component dataset.

Based on the above, the data encapsulation device and the data encapsulation method of the disclosure may automatically convert an original dataset into a structurally encapsulated data, and the structurally encapsulated data may be assembled and compiled into the executable data.

In order to make the above features and advantages of the disclosure more clearly understood, embodiments are given below and described in detail with reference to the accompanying drawings.

### BRIEF DESCRIPTION OF THE DRAWINGS

FIG. 1 is a circuit diagram of a data encapsulation device of an embodiment of the disclosure.

FIG. 2 is a flow chart of a data encapsulation method of an embodiment of the disclosure.

FIG. 3 is a schematic diagram of a data combining device of an embodiment of the disclosure.

FIG. 4 is a first schematic diagram of multiple modules of an embodiment of the disclosure.

FIG. 5 is a second schematic diagram of multiple modules of an embodiment of the disclosure.

FIG. 6 is a third schematic diagram of multiple modules of an embodiment of the disclosure.

FIG. 7 is a deployment schematic diagram of a terminal equipment, a server, and multiple modules of an embodiment of the disclosure.

### DETAILED DESCRIPTION OF DISCLOSED EMBODIMENTS

Reference will now be made in detail to exemplary embodiments of the disclosure. Examples of the exemplary embodiments are illustrated in the accompanying drawings. Whenever possible, the same reference numbers are used in the drawings and descriptions to refer to the same or similar parts.

It should be noted that a data encapsulation device and a data encapsulation method of the disclosure may simplify the difficulty and complexity of the design of the business processing flow and improve the reusability. A dataset described in the embodiments of the disclosure may be, for example, a material information in generative manufacturing, a bill in finance, or a leave request in a leave request flow. All the information may be abstractly defined as a dataset, and the dataset contains data content such as data type, status, characteristics, etc. Furthermore, there are corresponding processing logics for different types of datasets, so the disclosure may encapsulate the logics into component data. When encapsulating and assembling data flows, it is only necessary to define the attributes and relationships of entity data (that is, the attributes of multiple structurally encapsulated data, and the execution order between each other), and the data encapsulation device of the disclosure may automatically assemble and compile appropriate processing logics thereof (that is, executable data). In this way, data processing logic and user experience may be effectively encapsulated into processing logic (that is, encapsulated data), and then executable data is generated through assembly and parsing, thereby greatly simplifying the complexity of business processing flow encapsulation and improving reusability.

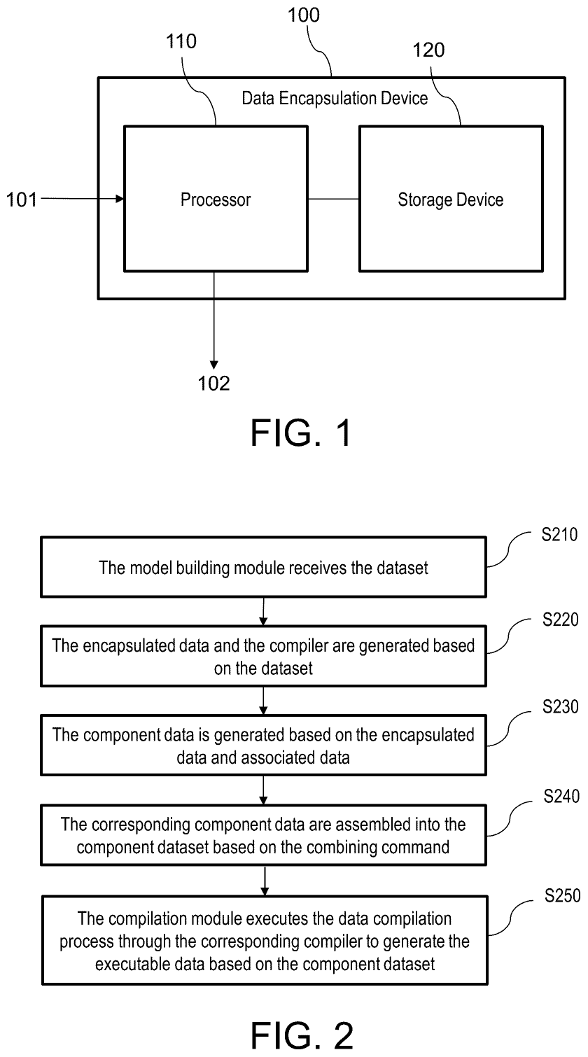

FIG. 1 is a circuit diagram of a data encapsulation device of an embodiment of the disclosure Referring to FIG. 1, a data encapsulation device 100 includes a processor 110 and a storage device 120. The processor 110 is coupled to the storage device 120. The data encapsulation device 100 may further include an input device, a user interface, a communication interface, or a data transmission interface, etc. which has actual circuit components, so that the processor 110 may receive an command or signal of a matching request from a data source or an external device or based on user operation. In the embodiment, the data encapsulation device 100 may be, for example, a personal computer, a workstation computer, or other electronic devices with data computing capabilities. In an embodiment, the data encapsulation device 100 may also be integrated into a cloud server or a private server within an enterprise. In an embodiment, the data encapsulation device 100 may be configured to implement an enterprise resource planning (ERP) system, and may execute multiple application programming interfaces (API) to invoke multiple business task modules.

In the embodiment, the processor 110 of the data encapsulation device 100 may include, for example, a central processing unit (CPU), or other programmable general-purpose or specific-purpose microprocessors, a digital signal processor (DSP), an application specific integrated circuit (ASIC), a programmable logic device (PLD), other similar processing circuits, or a combination of these devices.

In the embodiment, the storage device 120 may implement a remote cloud storage service or a local data storage service. The storage device 120 may include a memory and/or a database, wherein the memory may be, for example, a non-volatile memory (NVM). The storage device 120 may store relevant programs, modules, systems or algorithms configured to implement various embodiments of the disclosure, so as to be accessed and executed by the processor 110 to implement relevant functions and operations described in various embodiments of the disclosure. The storage device 120 may further be configured, for example, to cache the structurally encapsulated data described in the various embodiments of the disclosure.

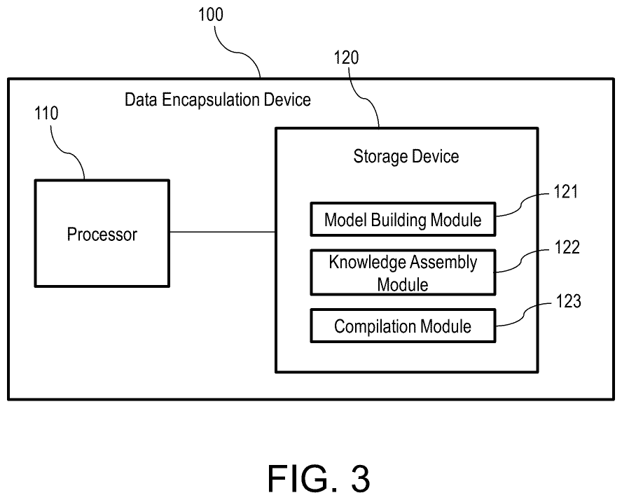

FIG. 2 is a flow chart of a data encapsulation method of an embodiment of the disclosure. FIG. 3 is a schematic diagram of a data combining device of an embodiment of the disclosure. Referring to FIG. 1, FIG. 2, and FIG. 3, the data encapsulation device 100 may perform the following steps S210 to S240. In step S210, the processor 110 may receive a dataset 101. In the embodiment, the processor 110 executes a model building module 121 to receive the dataset 101. The processor 110 of the data encapsulation device 100 may receive the dataset 101 from a data source. In this regard, the data source may be, for example, original business data or data obtained through an application port. Alternatively, the dataset 101 may also be data generated by certain sensors and specific data processing, environmental information, or manual settings.

In step S220, the processor 110 may obtain the structurally encapsulated data based on the dataset 101. In the embodiment, the processor 110 executes the model building module 121 to obtain encapsulated data 102 and a compiler based on the dataset 101 through the model building module 121. In the embodiment, the structurally encapsulated data refers to mapping certain things in the physical world into the digital domain and encapsulating into data. In the embodiment, the structurally encapsulated data may include a data type field, a data feature field, and an original data field (a field refers to describing and implementing by a language of a corresponding encoding program). In the embodiment, the structurally encapsulated data may also include other information such as environmental information.

In step S230, the processor 110 may execute a knowledge assembly module 122 to generate component data and associated data based on the encapsulated data 102 through the knowledge assembly module 122. Specifically, the knowledge assembly module 122 receives the encapsulated data 102 from the model building module 121, and the user inputs the associated data into the knowledge assembly module 122. In this way, the knowledge assembly module 122 may generate component data and associated data based on the encapsulated data 102. The associated data includes attribute data of the multiple encapsulated data 102 and data of relationships between the encapsulated data 102 (that is, relational data). The encapsulated data 102 may be data including a task logic. Furthermore, the associated data may be a task logic. A task logic refers to an algorithm or logic that may process the structurally encapsulated data, and the task logic may define a data range that the task logic itself is able to process.

In the embodiment, the dataset 101 includes at least one of entity data, feature data, relational data, and structured data. The encapsulated data 102 is equivalent to the model data. In another embodiment, the encapsulated data 102 is knowledge ontology model data, and each knowledge component may be designed by the knowledge design module based on a knowledge ontology model corresponding to the knowledge component and then stored in the storage device 120. Knowledge components include data such as component name, type, description, attributes, etc. For example, the ontology model may include data on procurement delivery dates, data on demand dates, processing logic for checking the rationality of procurement delivery dates, triggering conditions for procurement delivery dates not meeting default values, data on multiple solutions (for example, solutions to a problem with unsatisfactory procurement delivery dates may include negotiation and changing suppliers), as well as processing logic and associated data between the multiple data.

In step S240, the processor 110 may execute the knowledge assembly module 122 to assemble the corresponding at least one component data into a component dataset based on a combination command through the knowledge assembly module 122. In step S250, the processor 110 may execute a compilation module 123 to find the matching compiler based on the component dataset through the compilation module 123. Furthermore, the compilation module 123 executes a data compilation process through the corresponding compiler to generate the executable data based on the component dataset.

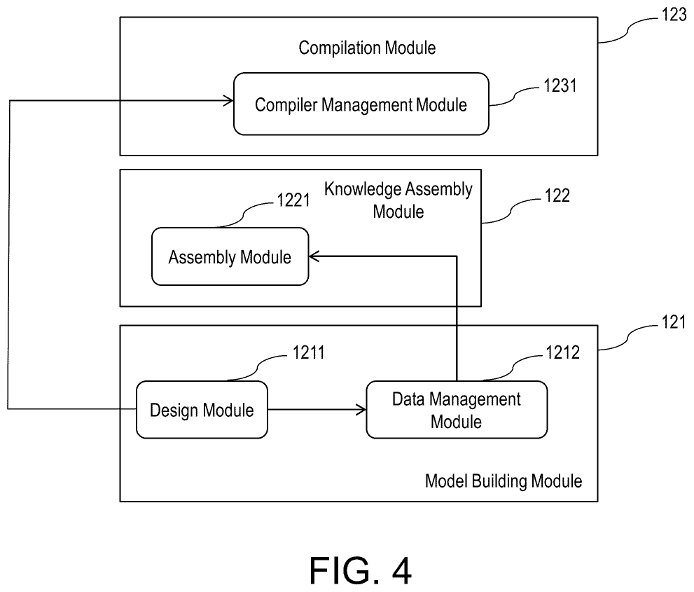

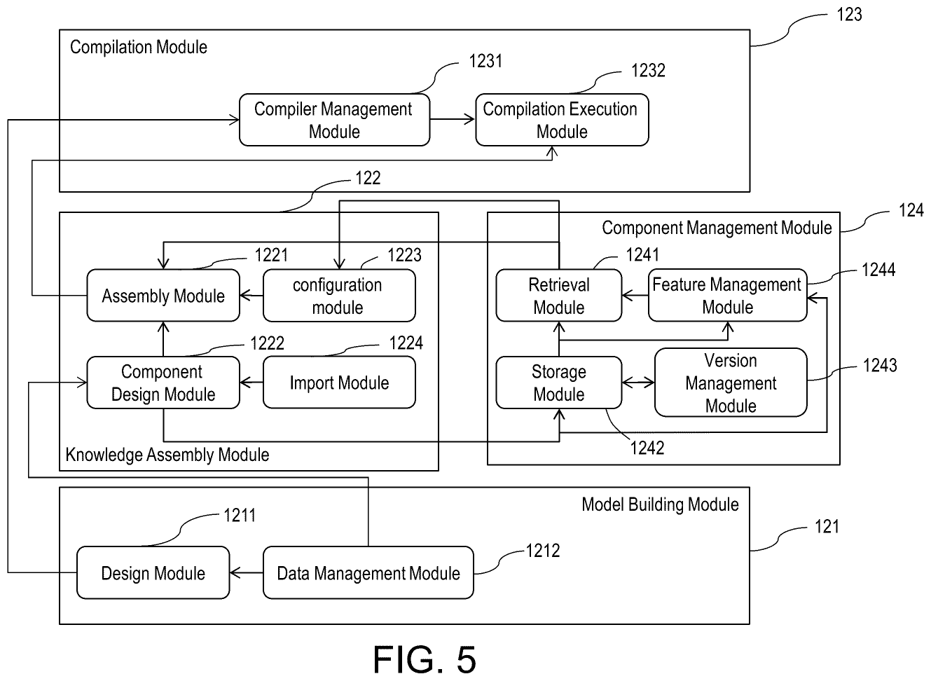

FIG. 4 is a first schematic diagram of multiple modules of an embodiment of the disclosure. FIG. 5 is a second schematic diagram of multiple modules of an embodiment of the disclosure. Referring to FIG. 1, FIG. 4, and FIG. 5, in the embodiment, the model building module 121 includes a design module 1211, a data management module 1212, and an executable data management module 1213. In this way, the model building module 121 receiving the dataset 101 to obtain the encapsulated data and the compiler based on the dataset includes the following steps. First, the processor 110 executes the design module 1211 to obtain the corresponding encapsulated data based on the dataset through the design module 1211. Furthermore, the data management module 1212 stores an encapsulated dataset and outputs the encapsulated dataset to an assembly module 1221 of the knowledge assembly module 122. In the embodiment, the executable data management module 1213 stores a parser comparison table and the executable data.

In an embodiment, the knowledge assembly module 122 includes a component design module 1222, and the design module 1211 generates an operation interface based on the encapsulated data to receive attribute data and relational data corresponding to each encapsulated data. Relational data is a relationship between multiple data, and may be, for example, the relationship between a purchase requisition (that is, data) and a purchase order (that is, data) that the purchase requisition is reviewed (that is, processing logic data) and converted (that is, processing logic data), and then the purchase order is formed. Specifically, the relational data may be an image and an association relationship between data before conversion and data after conversion. It is worth noting that data before compiling is more inclined to a semantic level, that is, a business logic description that is easy for people to understand, and the data after compiling is more inclined to a program logic that is easy for computers to understand. That is, compiled data is content (such as code) that a computer and a system may read and execute corresponding logic. For example, the data before compiling is “standard” and “check items,” and the data after compiling is the program logic described by a use script description. In an embodiment, the multiple modules of the data encapsulation device 100 further include a component management module 124. Furthermore, the component management module 124 includes a retrieval module 1241. The retrieval module 1241 searches for corresponding component data from the storage device 120 based on a retrieval command, and outputs the searched component data to the assembly module 1221. In an embodiment, the retrieval module 1241 may include an application program port to allow a user to input the retrieval command to the retrieval module 1241. The retrieval command includes multiple component data information, feature data, scenario data, and user type data. Feature data may be, for example, emergency indication, purchase order processing, and operating time features. The scenario data may be, for example, application scenarios of various processing logics such as management scenarios, and review scenarios. The user type data is related to the type of user, and may be, for example, a supervisor, an operator, an auditor, a data creator, etc.

In an embodiment, the knowledge assembly module 122 includes the component design module 1222. The component design module 1222 generates the operation interface based on the encapsulated data to receive attribute data and relational data corresponding to the encapsulated data. Specifically, a user may input attribute data and relational data through the operation interface. For example, the data management module 1212 of the model building module 121 inputs the encapsulated data to the component design module 1222, and then the component design module 1222 generates a corresponding operation interface based on the knowledge ontology (that is, encapsulated data), and then receives the attribute data (such as personnel information, comparison table, processing logic, etc.) and the relational data (such as a purchase order being formed after a purchase requisition is reviewed, a relationship between an unapproved data being approved and then an approved data being formed, etc.) of each entity (that is, single data, such as requisition data, purchase order data, employee data, and parameter values, etc.) through the user operating the operation interface.

In one embodiment, the knowledge assembly module 122 includes a configuration module 1223. The configuration module 1223 generates a configuration retrieval command based on the attribute data, and the retrieval module 1241 searches for corresponding configuration data from the storage device 120 based on the configuration retrieval command. Specifically, the configuration module 1223 searches for corresponding configuration data from the storage device 120 based on the attribute data input by a user. In this way, component data may be reused in applications with different scenarios but the same attributes. For example, the storage device 120 stores publishing execution data (that is, configuration data) related to a procurement scenario, and when the user inputs attribute data about a management scenario and a publishing flow, the retrieval module 1241 generates a publishing configuration retrieval command (that is, configuration retrieval command) based on the attribute data of the publishing flow. Next, the retrieval module 1241 searches for the publishing execution data from the storage device 120 based on the publishing configuration retrieval command. In this way, the data encapsulation device 100 achieves the function of data reuse.

In an embodiment, the compilation module 123 includes a compiler management module 1231 and a compilation execution module 1232. The compiler management module 1231 receives the encapsulated dataset and the compiler from the model building module 121 to build a compiler comparison table based on the compiler and the type of each encapsulated data in the encapsulated dataset. The compiler management module 1231 inputs the matching compiler corresponding to the component dataset to the compilation execution module 1232 based on the type of the component dataset and the compiler comparison table. The compilation execution module 1232 executes the data compilation process through the corresponding compiler to generate the corresponding executable data. The structurally encapsulated data (that is, encapsulated data) may be input into the compilation execution module 1232, so that the compilation execution module 1232 generates the corresponding executable data through the corresponding compiler. In the embodiment, the executable data may be different business logics respectively, and configured to process different business tasks (such as converting a purchase requisition to a purchase order, generating a leave request, etc.). The output data is business data.

In an embodiment, the component management module 124 includes a feature management module 1244. In this way, the retrieval module 1241 searching for the corresponding configuration data from the storage device 120 based on the configuration retrieval command includes the following steps. First, the feature management module 1244 matches corresponding feature information (such as attribute data) based on the configuration retrieval command. Furthermore, the retrieval module 1241 matches the corresponding configuration data from the storage device 120 based on the feature information. Specifically, the feature management module 1244 stores a configuration comparison table. In this way, the feature management module 1244 may generate the corresponding feature information based on the content of the component data and the encapsulated data (such as scenario data, attribute data, or associated data) to enable the retrieval module to search for the corresponding configuration data based on the feature information.

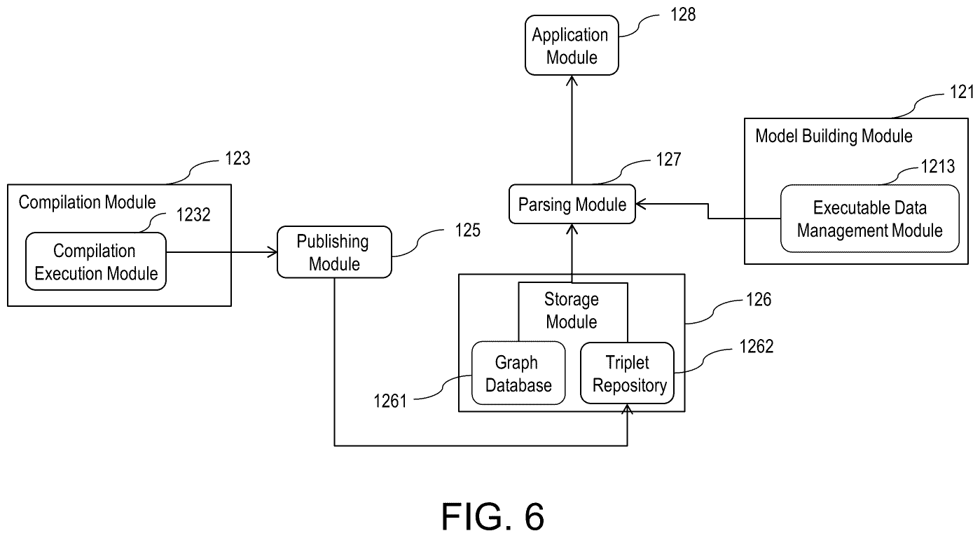

In an embodiment, the knowledge assembly module 122 includes an import module 1224, wherein the import module 1224 searches for structured data corresponding to the encapsulated data from the storage device 120 based on the encapsulated data. The knowledge assembly module 122 generates the component dataset from the multiple component data and at least one of the corresponding configuration data, attribute data, relational data, and structured data. The import module 1224 may import the structured data conforming to the encapsulated data into the component design module 1222 through RDB to RDF mapping language (R2RML). FIG. 6 is a third schematic diagram of multiple modules of an embodiment of the disclosure The data encapsulation device 100 further includes a publishing module 125, a storage module 126, a parsing module 127, and an application module 128. The publishing module 125 outputs the executable data to the server. The storage module 126 stores the executable data. In the embodiment, the storage module 126 may store the executable data in the form of at least one of a graph data, a file, and a triple. The parsing module 127 reads data from the storage module 126, and executes the corresponding task logic based on the type and content of the executable data to generate output data (that is, execution results, such as purchase order data, approval data, or verification results). The task logic is business logic, and the output data is business data.

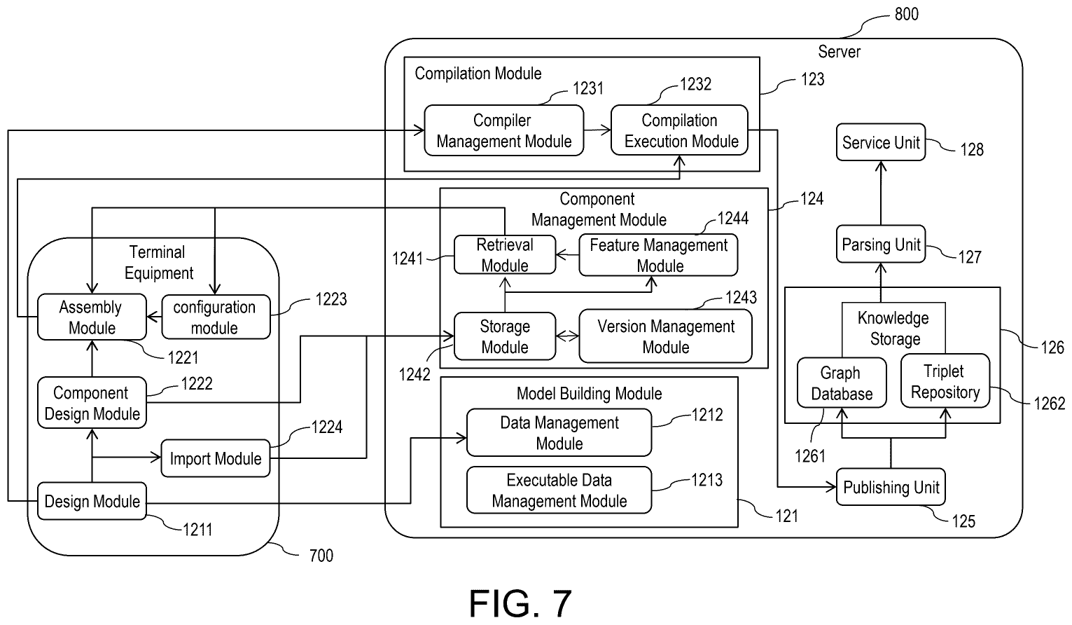

FIG. 7 is a deployment schematic diagram of a terminal equipment, a server, and multiple modules of an embodiment of the disclosure. It is worth noting that the data encapsulation device 100 may be deployed in a terminal equipment 700 and a server 800 operated by a user. Please refer to FIG. 7, the design module 1211, the component design module 1222, the assembly module 1221, the configuration module 1223, and the import module 1224 are disposed in the terminal equipment 700. Furthermore, remaining modules in the data encapsulation device 100 may be disposed in the server 800. In an embodiment, the design module 1211 describes the encapsulated data through the resource description framework (RDF). For example, the dataset 101 may include a purchase order data, a calculation logic for implementing a total quantity plan based on a purchase data, recording a calculation result in feature data, etc.

The data encapsulation device and the data encapsulation method of the disclosure may convert an original data (that is, dataset) into the structurally encapsulated data (that is, encapsulated data), and then assemble the data based on the structurally encapsulated data to obtain the corresponding component dataset. Furthermore, the component dataset may be compiled by the corresponding compiler to generate the executable data, thereby achieving to build a reusable and easy-to-operate data encapsulation device based on knowledge ontology design. In this way, the data encapsulation device 100 may efficiently generate knowledge ontology data, and has the effects of low operation threshold and ease to reuse the knowledge ontology data and the encapsulated data.

Finally, it should be noted that the above embodiments are only used to illustrate the technical solutions of the disclosure, and the embodiments are not limited thereto. Although the disclosure has been described in detail with reference to the embodiments, a person skilled in the art should understand that the technical solutions described in the embodiments may still be modified, or some or all of the technical features thereof may be replaced by equivalents. However, these modifications or substitutions do not cause the essence of the corresponding technical solution to depart from the scope of the technical solution of each embodiment of the disclosure.

What is claimed is:

1. A data encapsulation device, comprising:
a storage device, configured to store a plurality of modules and an encapsulated dataset; and
a processor, coupled to the storage device and configured to execute the plurality of modules,
wherein the plurality of modules comprise a model building module, a knowledge assembly module, and a compilation module,
wherein the model building module receives a dataset to obtain a corresponding encapsulated data and a compiler from the encapsulated dataset based on the dataset,
wherein the knowledge assembly module receives the encapsulated data to generate component data and associated data based on the encapsulated data,
wherein the knowledge assembly module assembles a plurality of the corresponding component data into a component dataset based on a combination command,
wherein the compilation module executes a data compilation process through the corresponding compiler to generate executable data based on the component dataset.

2. The data encapsulation device according to claim 1, wherein the dataset comprises at least one of entity data, feature data, relational data, and structured data, wherein the encapsulated data is model data.

3. The data encapsulation device according to claim 1, wherein the plurality of modules further comprise a component management module, wherein the component management module comprises a retrieval module,
wherein the knowledge assembly module comprises an assembly module,
wherein the retrieval module searches for the corresponding plurality of component data from the storage device based on a retrieval command, and outputs the searched plurality of component data to the assembly module.

4. The data encapsulation device according to claim 1, wherein the knowledge assembly module comprises a component design module, wherein the design module generates an operation interface based on the encapsulated data to receive attribute data and relational data corresponding to the encapsulated data.

5. The data encapsulation device according to claim 3, wherein the knowledge assembly module comprises a configuration module, wherein the configuration module generates a configuration retrieval command based on attribute data,
wherein the retrieval module searches for corresponding configuration data from the storage device based on the configuration retrieval command.

6. The data encapsulation device according to claim 5, wherein the component management module comprises a feature management module, wherein the feature management module matches corresponding feature information based on the configuration retrieval command, wherein the retrieval module matches the corresponding configuration data from the storage device based on the feature information.

7. The data encapsulation device according to claim 3, wherein the knowledge assembly module comprises an import module, wherein the import module searches for structured data corresponding to the encapsulated data from the storage device based on the encapsulated data,
wherein the assembly module generates the component dataset by assembling the plurality of component data and at least one of corresponding configuration data, attribute data, relational data, and the structured data.

8. The data encapsulation device according to claim 1, wherein the model building module comprises a design module, a data management module, and an executable data management module, wherein the design module obtains the corresponding encapsulated data based on the dataset,
wherein the data management module stores the encapsulated dataset and outputs the encapsulated dataset to an assembly module of the knowledge assembly module, wherein the executable data management module stores a parser comparison table and the executable data.

9. The data encapsulation device according to claim 1, wherein the compilation module comprises a compiler management module and a compilation execution module,
wherein the compiler management module receives the encapsulated data and the compiler from the model building module to establish a compiler comparison table based on a type of the compiler and the encapsulated data,
wherein the compiler management module inputs a matching compiler corresponding to the component dataset into the compilation execution module based on a type of the component dataset and the compiler comparison table,
wherein the compilation execution module executes the data compilation process through the matching compiler to generate the executable data.

10. The data encapsulation device according to claim 1, further comprising a publishing module, a storage module, and a parsing module, wherein the publishing module outputs the executable data to a server,
wherein the storage module stores the executable data, and the storage module stores the executable data in the form of one of a graph database, a file, and a triple,
wherein the parsing module executes a corresponding task logic based on a type of the executable data to generate output data, wherein the task logic is a business logic.

11. A data encapsulation method, comprising:
receiving a dataset through a model building module to obtain corresponding encapsulated data and a compiler from an encapsulated dataset based on the dataset;
receiving the encapsulated data through a knowledge assembly module to generate component data and associated data based on the encapsulated data;
assembling a plurality of the corresponding component data into a component dataset based on a combination command through the knowledge assembly module; and
executing a data compilation process through the corresponding compiler of a compilation module to generate executable data based on the component dataset.

12. The data encapsulation method according to claim 11, wherein the dataset comprises at least one of entity data, feature data, relational data, and structured data, and the encapsulated data is model data.

13. The data encapsulation method according to claim 11, further comprising:
searching for the corresponding plurality of component data from a storage device based on a retrieval command through a retrieval module, and outputting the searched plurality of component data to an assembly module.

14. The data encapsulation method according to claim 11, further comprising:
generating an operation interface based on the encapsulated data through a design module to receive attribute data and relational data corresponding to the encapsulated data.

15. The data encapsulation method according to claim 13, further comprising:
generating a configuration retrieval command based on attribute data through a configuration module; and
searching for a corresponding configuration data from the storage device based on the configuration retrieval command through the retrieval module.

16. The data encapsulation method according to claim 15, wherein the step of searching for the corresponding configuration data from the storage device based on the configuration retrieval command through the retrieval module comprises:
matching corresponding feature information based on the configuration retrieval command through a feature management module; and
matching the corresponding configuration data from the storage device based on the feature information through the retrieval module.

17. The data encapsulation method according to claim 13, further comprising:
searching for structured data corresponding to the encapsulated data from the storage device based on the encapsulated data through an import module; and
generating the component dataset by assembling the plurality of component data and at least one of corresponding configuration data, attribute data, relational data, and the structured data through the assembly module.

18. The data encapsulation method according to claim 11, wherein the step of receiving the dataset to obtain the corresponding encapsulated data and the compiler based on the dataset through the model building module comprises:
generating the encapsulated data based on the dataset through a design module;
storing the encapsulated data through a data management module, and outputting the encapsulated data to an assembly module of the knowledge assembly module; and
storing a parser comparison table and the executable data through an executable data management module.

19. The data encapsulation method according to claim 11, further comprising:
receiving the encapsulated data and the compiler from the model building module through a compiler management module to establish a compiler comparison table based on a type of the compiler and the encapsulated data;
inputting a matching compiler corresponding to the component dataset into a compilation execution module based on a type of the component dataset and the compiler comparison table through the compiler management module; and
executing the data compilation process through the matching compiler of the compilation execution module to generate the executable data.

20. The data encapsulation method according to claim 11, further comprising:
storing the executable data through a storage module, wherein the storage module stores the executable data in the form of one of a graph database, a file, and a triple; and
executing a corresponding task logic based on a type of the executable data through a parsing module to generate output data, wherein the task logic is business logic.
